(19) United States
(12) Patent Application Publication
(10) Pub. No.: US 2007/0065568 A1
(43) Pub. Date: Mar. 22, 2007

(54) Method for Producing a Smoked TOFU

(75) Inventor: Shimpei Nishimura, Higashi-Osaka-shi (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HOUSE FOODS CORPORATION, Higashi-Osaka-shi (JP)

(21) Appl. No.: 11/531,765

(22) Filed: Sep. 14, 2006

(30) Foreign Application Priority Data
Sep. 20, 2005 (JP) 2005-272130

(51) Int. Cl. A23L 1/20

(52) U.S. Cl. 426/634

(57) ABSTRACT

It is therefore an object of the present invention to provide a method for producing a smoked TOFU which allows applying of a desirable brownish color and a smoked flavor to the TOFU in a short time and enables the smoked TOFU to be stored for a long time. The present invention provides a method for producing a smoked TOFU, comprising the steps of: preparing TOFU from soy milk having the brix in a range of 1.5 to 14; soaking said TOFU in a flavoring liquid containing an amino acid; drying said TOFU; and smoking said TOFU for 60 minutes or less.

### BACKGROUND OF THE INVENTION

1. Field of the Invention

The present invention relates to a method for producing a smoked TOFU (soybean curd) which allows applying of a desirable brownish color and a smoked flavor to the TOFU in a short time and enables the smoked TOFU to be stored for a long time.

2. Description of the Related Art

A smoked TOFU is a type of processed TOFU that has been known in the prior art, a producing method of which smoked TOFU has required conducting of dehydration and/or smoking processes for a long time. For example, a product of TOFU called Motaikohboh has been typically obtained in a method in which TOFU that has been prepared to be rather hard by using a large quantity of domestically produced soybeans is embedded and left as it is overnight in a soybean paste called Miso, and after it is dried, a resultant TOFU is smoked through a smoking process with an amount of chips of cherry wood for 4 hours, this whole process substantially taking two full days.

In addition, there has been alternative method for producing a smoked TOFU, which is characterized in that, firstly, the proper quantity of water is squeezed out of the TOFU under a pressure that does not cause the collapse of the TOFU; secondly, the TOFU is embedded in soybean paste called Miso and then subject to a smoking process for producing the smoked TOFU (see Japanese Patent Laid-open Publication No. H07-289195). In this method, however, the smoking time cited in the description is in a range of 4 to 8 hours, meaning that a long period of time for conducting the smoking process is required.

There has been another type of processed TOFU, differently from the smoked TOFU as described above, which is characterized by its production method, in which, firstly, TOFU that has been pressed to let water be released out of the TOFU is soaked into a flavoring liquid, secondly, this soaked TOFU is wrapped with a paper towel and then placed on a sheet of aluminum foil, which is then dried while being enclosed entirely with a carbide layer comprising small particles of carbide, and, thirdly, the thus processed TOFU is taken out of the carbide layer and vacuum packaged, which package is further sterilized to make the processed TOFU product (see Japanese Patent Laid-open Publication No. 2004-135641). In the description of this method, however, the time required for drying the TOFU while enclosing it entirely with the layer of carbide is in a range of 7 to 12 hours, or 14 days at the longest.

### BRIEF SUMMARY OF THE INVENTION

It is therefore an object of the present invention to provide a method for producing a smoked TOFU which allows applying of a desirable brownish color and a smoked flavor to the TOFU in a short time and enables the smoked TOFU to be stored for a long time.

The present invention provides a method for producing a smoked TOFU, comprising the steps of: preparing TOFU from soy milk having the brix in a range of 1.5 to 14; soaking said TOFU in a flavoring liquid containing an amino acid; drying said TOFU; and smoking said TOFU for 60 minutes or less.

### DETAILED DESCRIPTION OF THE INVENTION

A method for producing a smoked TOFU of the present invention comprises the steps of preparing TOFU from soymilk, soaking said TOFU in a flavoring liquid containing an amino acid, drying it, and then smoking said TOFU.

The soymilk used in the present invention can be categorized into two types: one not including okara (bean curd refuse); and the other, referred to as a whole-grain soymilk, including the okara.

Preferably, the soymilk used in the present invention may be the one having the brix in a range of 1.5 to 14. A higher amount of brix would make the resultant TOFU soft, while a lower amount of brix would increase an amount of water called “Yu” (water to be released when the TOFU is squeezed), leading to deteriorated workability.

First, a method of preparing TOFU using the soymilk including no okara will be explained. A soymilk having the brix in a range of 3 to 8 is heated to a temperature in a range of 60° C. to 95° C., an aqueous solution containing a coagulating agent and a common salt dissolved therein is added to the heated soymilk and it is stirred sufficiently. Then a resultant mixture is left in a hot bath at a temperature in a range of 60° C. to 95° C. for 15 to 45 minutes to allow it to coagulate. The coagulating agent may include calcium chloride, calcium sulfate, gluconic delta lactone, bittern or the like, and preferably the calcium chloride may be used in order to make the resultant TOFU harder. The higher the concentration of the calcium chloride is, the harder the TOFU will be. A preferred amount of the calcium chloride to be added may be in a range of 0.2% by mass to 1.2% by mass relative to the amount of the soymilk. Besides, the common salt is added to the soymilk for the purpose of making the TOFU tasty, but it is not necessarily added. It should be remembered that addition of an excess amount of common salt would produce soft TOFU. A preferred amount of the common salt to be added may be in a range of 0% by mass to 0.5% by mass relative to the amount of the soymilk. A forming box lined with cotton cloth is then filled with the TOFU that has been collapsed to be sufficiently fine, closed by a lid and placed under pressure until the water content of the TOFU is reduced to 75% by mass. This pressing may take place under the pressure of 10 g/cm² to 20 g/cm² for 5 to 30 minutes, and then under the pressure of 100 g/cm² to 200 g/cm² for 10 to 60 minutes.

In an alternative aspect of the above method, a soymilk with no okara contained therein and having the brix in a range of 8 to 14 is heated to a temperature in a range of 60° C. to 80° C., an aqueous solution containing a coagulating agent and a common salt dissolved therein is added to the heated soymilk, and it is stirred sufficiently. Then, a resultant mixture is left in a hot bath at a temperature in a range of 60° C. to 80° C. for 15 to 45 minutes to allow it to coagulate. Preferably, the bittern may be used as the coagulating agent in order to make the resultant TOFU soft. A preferred amount of the bittern to be added may be in a range of 0.6% by mass to 1.6% by mass relative to the amount of the soymilk. Besides, the common salt is added to the soymilk for the purpose of making the TOFU tasty, but it is not necessarily added. It should be remembered that addition of an excess amount of common salt would produce soft TOFU. A preferred amount of the common salt to be added may be in a range of 0% by mass to 0.5% by mass relative to the amount of the soymilk. A forming box lined with cotton cloth is then filled with the TOFU that has been collapsed to be sufficiently fine, closed with a lid and placed under pressure until the water content of the TOFU is reduced to 75% by mass. This pressing may take place under the pressure of 10 g/cm² to 20 g/cm² for 5 to 30 minutes, and then under the pressure of 100 g/cm² to 200 g/cm² for 10 to 60 minutes, similarly to the foregoing pressing done in the above method.

In yet another aspect of the above method, a whole-grain soymilk having the brix in a range of 1.5 to 5, which has been obtained by dispersing a soybean flour (a powder form of soybeans obtained by crushing the soy beans directly, with an outer skin of the soybean having been removed or left as it is) into water and then heating it, is heated to a temperature in a range of 60° C. to 95° C., an aqueous solution containing calcium chloride and common salt dissolved therein is added to the heated whole-grain soymilk, and it is stirred sufficiently. Then, a resultant mixture is left in a hot bath at a temperature in a range of 60° C. to 95° C. for 15 to 45 minutes to allow it to coagulate. To produce the TOFU from the whole-grain soymilk, if the same brix range suitable for the soymilk including no okara is applied to the whole-grain soymilk used for producing the TOFU, the resultant TOFU would be hard, owing to fibers of okara contained in the whole-grain soymilk. Due to this reason, the whole-grain soymilk, which has a lower brix range than the soymilk including no okara, may be coagulated. Preferably the calcium chloride may be used in order to make the resultant TOFU harder and in this regard, the higher the concentration of the calcium chloride is, the harder the TOFU will be. A preferred amount of the calcium chloride to be added may be in a range of 0.2% by mass to 1.2% by mass relative to the amount of the soymilk. Besides, the common salt is added to the soymilk for the purpose of making the TOFU tasty, but it is not necessarily added. It should be remembered that addition of an excess amount of common salt would produce soft TOFU. A preferred amount of the common salt to be added may be in a range of 0% by mass to 0.5% by mass relative to the amount of the soymilk. A forming box lined with cotton cloth is then filled with the TOFU that has been collapsed to be sufficiently fine, closed by a lid and pressed under the pressure of 10 g/cm² to 20 g/cm² for 5 to 30 minutes, and then under the pressure of 100 g/cm² to 200 g/cm² for 10 to 60 minutes so as to allow the water content to decrease approximately to 75% by mass.

Further in still another aspect of the above method, a whole-grain soymilk, which has been obtained by dispersing a soybean flour into water and then heating it (a powder of soybeans made by crushing the soy beans directly, with an outer skin of the soybean having been removed or left as it is), the whole-grain soymilk having the brix in a range of 5 to 10 is heated to a temperature in a range of 60° C. to 80° C., an aqueous solution containing bittern and common salt dissolved therein is added to the heated whole-grain soymilk, and it is stirred sufficiently. Then, a resultant mixture is left in a hot bath at a temperature in a range of 60° C. to 80° C. for 15 to 45 minutes to allow itself to coagulate. To produce the TOFU from the whole-grain soymilk, if the same brix range suitable for the soymilk including no okara is applied to the whole-grain soymilk used for producing the TOFU, the resultant TOFU would be hard, owing to fibers of okara contained in the whole-grain soymilk. Due to this reason, the material from the whole-grain soymilk, which has a lower brix range than the soymilk including no okara, may be coagulated. The bittern may be added in order to obtain the TOFU coagulated to be soft. A preferred amount of the bittern to be added may be in a range of 0.6% by mass to 1.6% by mass relative to the amount of the soymilk. Besides, the common salt is added to the soymilk for the purpose of making the TOFU tasty, but it is not necessarily added. It should be remembered that addition of an excess amount of common salt would produce soft TOFU. A preferred amount of the common salt to be added may be in a range of 0% by mass to 0.5% by mass relative to the amount of the soymilk. A forming box lined with cotton cloth is then filled with the TOFU that has been collapsed to be sufficiently fine, closed with a lid and pressed under the pressure of 10 g/cm² to 20 g/cm² for 5 to 30 minutes, and then under the pressure of 100 g/cm² to 200 g/cm² for 10 to 60 minutes so as to allow the water content to decrease approximately to 75% by mass.

Subsequently, the thus prepared TOFU is soaked in a flavoring liquid containing an amino acid. The amino acid used in the present invention may include glutamic acid, glutamine, glycine, alanine, phenylalanine, leucine, isoleucine, valine, systeine and so on. The flavoring Liquid containing the amino acid may be a liquefied form of an appropriate combination of soy sauce, soybean paste and a kind of soup stock or Japanese soup stock, which may be mixed with the above listed amino acids and other flavoring materials, as desired. A preferred flavoring liquid containing the amino acid used in the present invention may be one based on soy sauce, comprising mainly soy sauce or consomme, to which soy sauce some flavoring materials are appropriately added and which soy sauce is then diluted with some Japanese soup stock or a chicken soup stock. In addition, sugars such as sucrose, lactose and oligosaccharide may be added to the flavoring liquid.

It is preferred to boil the TOFU while it is being soaked in the flavoring liquid containing the amino acid.

If carried out at a temperature range between a low temperature and room temperature, the soaking needs to be continued for a period of from a few hours to a full day to allow a flavor to penetrate into the TOFU and thus may cause a problem of bacterial proliferation. On the other hand, boiling at a high temperature accelerates the penetration rate so that the flavoring can penetrate into the TOFU in a time of from a few minutes to several dozen minutes and also eliminates the problem of bacterial proliferation.

Preferably, a boiling period may be in a range of 10 minutes to 60 minutes, more preferably 15 minutes to 45 minutes.

Then, the TOFU is taken out of the flavoring liquid and subject to the drying process. The drying process may be carried out by using any known equipment including an oven and a smoker. Preferably, the TOFU may be dried at a temperature in a range of 80° C. to 120° C. for 60 minutes to 140 minutes The drying process removes any excess water content from the TOFU, so that the TOFU can be reduced in size and thus turn rigid, thereby preventing the TOFU from collapsing. In addition, the drying process modifies the color of a surface of the TOFU so as to be brownish or to be a desired color tone. More preferably, the drying process may be carried out at a temperature in a range of 90° C. to 110° C. for 80 minutes to 120 minutes. Preferably, the water content in the TOFU after the drying process may be in a range of 50% to 80% by mass, more preferably 60% to 70% by mass.

The dried TOFU is further subjected to the smoking process. The smoking process provides the TOFU with a smoking flavor and also turns the TOFU more brownish. In the present invention, the smoking process may be carried out at a temperature in a range of 80° C. to 140° C. and can be advantageously completed within 60 minutes, preferably within a range of 3 minutes to 30 minutes. A material for making smoke to be used in the smoking process may include cherry, beech, oak, apple, walnut and white walnut woods and sawn wood, and preferably the cherry wood is used in view of its good flavor.

It is preferred that the TOFU be cooled immediately after the smoking process. Preferably, the TOFU may be cooled down to a temperature in a range of 0° C. to 25° C., more preferably in a range of 5° C. to 10° C. Decreasing the temperature of the TOFU can help avoid bacterial proliferation or deteriorated flavoring.

Once the smoking process is finished, the TOFU is packed in a pouch, which is in turn sealingly closed, preferably by using a vacuum (deaeration) sealing, for the distribution of the TOFU as a chilled product. Preferably, the pouch having a low oxygen permeability is used, in which a material thereof is not specifically limited but preferably one provided with aluminum foil that has been laminated or deposited over the surface of the pouch or one applied with a silica deposition or an alumina deposition over the surface thereof. Further, in order to achieve a long shelf life for the product, the packed TOFU may be subject to retort sterilization after the vacuum sealing process, in which the vacuum sealing can help reduce the time required for the retort sterilization. The pouch may be one having low oxygen permeability as well as sufficient durability to withstand expected handling of the retort product.

### EXAMPLES

### Example 1

TOFU Produced by Using Soymilk Including no Okara—a Hard Type

Soymilk was obtained through a process comprising the steps of soaking soybeans in water at a room temperature for ten hours; draining off water; adding water in a quantity three times as much as by mass thereof to the soaking soybeans; grinding the soaking soybeans into a mash of soybeans; heating a resultant mash of soybeans at 100° C. for two minutes; and separating the mash of soybeans into a soymilk part and okara part by using a squeezing machine to produce the soymilk. The brix of the soymilk was measured, and then water was added to the soymilk in order to control the brix so that the brix is 5.5. The resultant soymilk having the brix of 5.5 in an amount of 96 parts by mass was heated to 85° C., to which an aqueous solution comprising a mixture of calcium chloride in an amount of 0.5 parts by mass, common salt in an amount of 0.3 parts by mass, and water in an amount of 3.2 parts by mass was added, and then stirred sufficiently. The resultant material was then left as it was at 85° C. for 30 minutes to allow it to coagulate to produce TOFU. Subsequently, a forming box lined with wet cotton cloth was filled with the TOFU that had been collapsed to be sufficiently fine, closed by a lid and pressed under the pressure of 18 g/cm² for 5 minutes and then 180 g/cm² for 50 minutes. A water content in the TOFU after the pressing process was 75% by mass.

Subsequently, one unit block of TOFU was cut into four equal parts and soaked in a flavoring liquid comprising common salt in an amount of 3 parts by mass, soy sauce in an amount of 10 parts by mass, Ajinomoto consommé soup stock in an amount of 5 parts by mass and water in an amount of 82 parts by mass, and then boiled for 30 minutes.

Each quarter of the TOFU was respectively taken out of the flavoring liquid and an oven was used to dry each quarter of the TOFU at 100° C. for 100 minutes. The water content in each quarter of the TOFU after the drying process was 66% by mass.

Subsequently, each quarter of the TOFU was subject to a smoking process at a temperature approximately in a range of 90° C. to 110° C. for 15 minutes in a cylindrical smoker by using cherry wood as the smoking material.

The thus obtained smoked TOFU was packed in a retort pouch, which was in turn vacuum sealed. The package was further sterilized at 122° C. for 14 minutes by using a spray type retort sterilizing machine.

The thus obtained smoked TOFU had a smoked cheese-like flavor and texture which gave people a feeling as if they were eating smoked cheese. In addition, no occurrence of any color fading, deteriorated flavor or unpleasent odor resulting from oxidization of fat was observed, even after an elapsed time of 12 months from the starting of storage, and thus no problem of storage stability arose.

### Example 2

TOFU Produced by Using Soymilk Including No Okara—a Soft Type

A brix of commercially available plain soymilk was measured, and then water was added to the soymilk in order to control the brix so that the brix is 11.0. The thus obtained soymilk having the brix of 11.0 in an amount of 95 parts by mass was heated to 70° C., to which an aqueous solution comprising a mixture of bittern in an amount of 1 parts by mass, common salt in an amount of 0.3 parts by mass, and water in an amount of 3.7 parts by mass was added, and then stirred sufficiently. The resultant material was then left as it was at 70° C. for 30 minutes to allow it to coagulate to produce TOFU. Subsequently, a forming box lined with wet cotton cloth was filled with the TOFU that had been collapsed to be sufficiently fine, closed by a lid and pressed under the pressure of 12 g/cm² for 10 minutes and then 120 g/cm² for 20 minutes. A water content in the TOFU after the pressing process was 79.6% by mass.

Subsequently, one unit block of TOFU was cut into four equal parts and soaked in a flavoring liquid comprising common salt in an amount of 3 parts by mass, soy sauce in an amount of 10 parts by mass, Ajinomoto consommé soup stock in an amount of 5 parts by mass and water in an amount of 82 parts by mass, and then boiled for 30 minutes Each quarter of the TOFU was respectively taken out of the flavoring liquid and an oven was used to dry each quarter of the TOFU at 100° C. for 100 minutes. The water content in each quarter of the TOFU after the drying process was 71% by mass.

Subsequently, each quarter of the TOFU was subject to a smoking process at a temperature approximately in a range of 90° C. to 110° C. for 15 minutes in a cylindrical smoker by using cherry wood as the smoking material.

The thus obtained smoked TOFU was packed in a retort pouch, which was in turn vacuum sealed. The package was further sterilized at 122° C. for 14 minutes by using a spray type retort sterilizing machine.

The thus obtained smoked TOFU had a smoked cheese-like flavor and texture which gave people a feeling as if they were eating smoked cheese. In addition, no occurrence of any color fading, deteriorated flavor or unpleasant odor resultant from oxidization of fat was observed, even after an elapsed time of 12 months from the starting of storage, and thus no problem of storage stability arose.

### Example 3

TOFU Produced by Using Whole-grain Soymilk—a Hard Type

Soybean flour was obtained through a process comprising the steps of removing outer skins of soybeans, drying the peeled soybeans at 50° C. for 12 hours, and then crushing the soybeans by a crusher to produce the soybean flour. Water in an amount of 80 parts by mass was added to the thus obtained soybean flour in an amount of 20 parts by mass, which was uniformly mixed by a mixer and heated at 100° C. for two minutes to produce soymilk. The brix of the obtained soymilk was measured, and water was added to the soymilk to control the brix so that the brix is 3.5. The resultant whole-grain soymilk having the brix of 3.5 in an amount of 96 parts by mass was heated to 80° to which an aqueous solution comprising a mixture of calcium chloride in an amount of 0.5 parts by mass, common salt in an amount of 0.3 parts by mass, and water in an amount of 3.2 parts by mass was added, and then stirred sufficiently. The resultant material was then left as it was at 80° C. for 30 minutes to allow it to coagulate to produce TOFU. Subsequently, a forming box lined with wet cotton cloth was filled with the TOFU that had been collapsed to be sufficiently fine, closed with a lid and pressed under the pressure of 18 g/cm² for 15 minutes and then 180 g/cm² for 45 minutes. A water content in the TOFU after the pressing process was 77.8% by mass.

Subsequently, one unit block of TOFU was cut into four equal parts and soaked in a flavoring liquid comprising common salt in an amount of 3 parts by mass, soy sauce in an amount of 10 parts by mass, Ajinomoto consommé soup stock in an amount of 5 parts by mass and water in an amount of 82 parts by mass, and then boiled for 30 minutes.

Each quarter of TOFU was respectively taken out of the flavoring liquid and an oven was used to dry each quarter of the TOFU at 100° C. for 100 minutes. The water content in each quarter of the TOFU after the drying process was 68.2% by mass.

Subsequently, each quarter of the TOFU was subject to a smoking process at a temperature approximately in a range of 90° C. to 110° C. for 15 minutes in a cylindrical smoker by using cherry wood as the smoking material.

The thus obtained smoked TOFU was packed in a retort pouch, which was in turn vacuum sealed. The package was further sterilized at 122° C. for 14 minutes by using a spray type retort sterilizing machine.

The thus obtained smoked TOFU took on a smoked cheese-like flavor and texture which gave people a feeling as if they were eating smoked cheese. In addition, no occurrence of any color fading, deteriorated flavor or unpleasant odor resultant from oxidization of fat was observed, even after an elapsed time of 12 months from the starting of storage, and thus no problem of storage stability arose.

### Example 4

TOFU Produced by Using Hole-grain Soymilk—a Soft Type

Water in an amount of 80 parts by mass was added to commercially available soybean flour in an amount of 20 parts by mass, which was uniformly mixed by a mixer and heated at 100° C. for two minutes to produce soymilk. The brix of the obtained soymilk was measured, and then water was added to the soymilk to control the brix so that the brix is 8.5. The resultant whole-grain soymilk having the brix of 8.5 in an amount of 95 parts by mass was heated to 75° C., to which an aqueous solution comprising a mixture of bittern in an amount of 1 parts by mass, common salt in an amount of 0.3 parts by mass, and water in an amount of 3.7 parts by mass was added, and then stirred sufficiently. The resultant material was then left as it was at 75° C. for 30 minutes to allow it to coagulate to produce TOFU. Subsequently, a forming box lined with wet cotton cloth was filled with the TOFU that had been collapsed sufficiently fine, closed with a lid and pressed under the pressure of 12 g/cm² for 10 minutes and then 120 g/cm² for 20 minutes. A water content in the TOFU after the pressing process was 80.5% by mass.

Subsequently, one unit block of TOFU was cut into four equal parts and soaked in a flavoring liquid comprising common salt in an amount of 3 parts by mass, soy sauce in an amount of 10 parts by mass, Ajinomoto consommé soup stock in an amount of 5 parts by mass and water in an amount of 82 parts by mass, and then boiled for 30 minutes.

Each quarter of TOFU was respectively taken out of the flavoring liquid and an oven was used to dry each quarter of the TOFU at 100° C. for 100 minutes. The water content in each quarter of the TOFU after the drying process was 69.1% by mass.

Subsequently, each quarter of the TOFU was subject to a smoking process at a temperature approximately in a range of 90° C. to 110° C. for 15 minutes in a cylindrical smoker by using cherry wood as the smoking material.

The thus obtained smoked TOFU was packed in a retort pouch, which was in turn vacuum sealed. The package was further sterilized at 122° C. for 14 minutes by using a spray type retort sterilizing machine.

The thus obtained smoked TOFU had a smoked cheese-like flavor and texture which gave people a feeling as if they were eating the smoked cheese. In addition, no occurrence of any color fading, deteriorated flavor or unpleasant odor resultant from oxidization of fat was observed, even after an elapsed time of 12 months from the starting of storage, and thus no problem of storage stability arose.

What is claimed is:

1. A method for producing a smoked TOFU, comprising the steps of:
preparing TOFU from soy milk having the brix in a range of 1.5 to 14;
soaking said TOFU in a flavoring liquid containing an amino acid;
drying said TOFU; and
smoking said TOFU for 60 minutes or less.

2. A method for producing a smoked TOFU of claim 1, in which said TOFU is boiled during the step of soaking said TOFU in the flavoring liquid containing the amino acid.

3. A method for producing a smoked TOFU of claim 1, in which the drying step is carried out at a temperature in a range of from 80 to 120° C. for from 60 to 140 minutes.

4. A method for producing a smoked TOFU of claim 1, in which a water content in the TOFU after the drying step is in a range of from 50 to 80% by mass.

5. A method for producing a smoked TOFU of claim 1, in which the smoking step is carried out at a temperature in a range of from 80 to 140° C. for from 3 to 30 minutes.

6. A method for producing a smoked TOFU of claim 1, further comprising the steps of:
packing the TOFU after the smoking step in a retort pouch;
sealing the retort pouch; and
subjecting the retort pouch to retort sterilization.

7. A method for producing a smoked TOFU of claim 1, in which after the TOFU is packed in the retort pouch, the retort pouch is sealed using a vacuum seal.
